(19) United States
(12) Patent Application Publication
(10) Pub. No.: US 2020/0114474 A1
(43) Pub. Date: Apr. 16, 2020

(54) SOLDER PASTE CONTAINING LEAD FREE SOLDER COMPOSITION WITH HIGH DUCTILITY AND SOLDERING FLUX

(71) Applicant: Hebei Lixin Technology Co., Ltd, Handan (CN)

(72) Inventor: Lixin ZHOU, Handan (CN)

(21) Appl. No.: 16/161,326

(22) Filed: Oct. 16, 2018

(51) Int. Cl. B23K 35/26; B23K 35/36; C08L 93/04; C08K 5/13; C08K 5/05; C08K 5/08

(52) U.S. Cl. CPC B23K 35/26; B23K 35/3613; C08K 5/08; C08K 5/13; C08K 5/05; C08L 93/04

(57) ABSTRACT

A solder paste containing a lead free solder composition and a soldering flux is disclosed, the lead free solder composition including: 0.02%-6% by weight stibium, 0.03%-3% by weight copper, 0.03%-8% by weight bismuth, 42%-70% by weight indium, 0.3%-8% by weight silver, 5%-11% by weight magnesium, 0.8%-1.6% by weight scandium, 0.7%-2.0% by weight yttrium, and 10%-45% by weight tin, and the soldering flux including: 25%-32% by weight rosin, 5%-7% by weight a mixture of pentane diacid and 2-Fluorobenzoic acid, as an organic acid activator; 0.2%-0.5% by weight alkylphenol polyoxyethylene, as a surface active agent; 0.7%-0.8% by weight 1-octyl alcohol, as a defoaming agent; 0.5%-0.7% by weight hydroquinone, as a stabilizer; and 20%-32% by weight a monoalkyl propylene glycol-based solvent.

### TECHNICAL FIELD

The present invention relates to a solder paste containing a lead free solder composition with high ductility and a soldering flux.

### TECHNICAL BACKGROUND

Rear windows of automobiles typically include electrical devices, such as defrosters, located on the glass. In order to provide electrical connections to the electrical devices, a small area of metallic coating is generally applied to the glass to obtain a metalized surface which is configured to be electrically connected to the electrical device, and then an electrical connector of the electrical device can be soldered onto the metalized surface.

In the prior art, the electrical connector is soldered onto the metalized surface on the glass with a solder containing lead (Pb). However, due to environmental pollution caused by lead, the use of lead is more and more limited, and hence a lead free solder begins to be used in soldering applications. For example, a common lead free solder containing a high tin (Sn) content such as more than 80% is employed in some industries.

However, the glass is brittle, thus the common lead free solder with a high tin content tends to cause cracking of the glass while soldering the electrical device onto the glass. Moreover, soldering two materials (such as glass and cooper) which differ substantially in Coefficient of thermal expansion (CTE) imposes stress on the solder either during cooling of the solder joint or during subsequent temperature excursions. Therefore, on one hand, the solder composition suitable for soldering the electrical device onto the glass needs to have a melting point (i.e. liquidus temperature) that is low enough to not cause cracking of the automotive glass during the soldering process, because a higher melting point and correspondingly higher processing temperature augments the adverse effects of CTE mismatch, imposing higher stress on the solder during cooling. As a result, the solder is further required to have good Ductility. On the other hand, the melting point of the solder composition needs to be high enough, so that the solder will not melt during the normal usage of the automobile, such as when the car is in the sun with the windows closed or under other extreme harsh environmental conditions.

Conventionally already disclosed is a lead free solder composition with a weight percentage of 64.35%-65.65% indium (In), 29.7%-30.3% tin (Sn), 4.05%-4.95% silver (Ag) and 0.25%-0.75% copper (Cu) (hereinafter referred to as the “65 Indium Solder”).

Solders that contain indium, however, normally have much lower melting points than other solders. The 65 Indium Solder, for example, has a solidus temperature of 109° C., compared to 160° C. of the lead solder, and a liquidus temperature of 127° C., compared to 224° C. of the lead solder. Generally, a higher indium content in the solder causes a lower solidus temperature of the solder. Some vehicle manufacturers desire that the solder joint should be capable of surviving elevated temperatures, accordingly the solder with a indium content should have a solidus temperature no lower than 120° C. and have a good ductility at a temperature range from −40° C. to 120° C., without any deterioration in performance.

Further, in soldering a plurality of electrical connectors arranged closely, the soldering of an electrical connector will affect the adjacent soldered electrical connector, and hence the solder must have high stability and ductility, otherwise remelting and cracking of the adjacent electrical connector will likely occur.

A soldering flux is a necessary additive for the soldering. For the above solder composition as desired, a suitable soldering flux is required, so that the solder paste formed by the solder composition and the soldering flux can maintain stickiness during long-time storage, excessive residues are not caused by the soldering flux during soldering, and the circuit board undergone soldering can be cleaned easily.

### SUMMARY

Accordingly, an object of the invention is to provide a solder paste containing a lead free solder composition and a soldering flux, where the lead free solder composition includes: 0.02%-6% by weight stibium, 0.03%-3% by weight copper, 0.03%-8% by weight bismuth, 42%-70% by weight indium, 0.3%-8% by weight silver, 5%-11% by weight magnesium, 0.8%-1.6% by weight scandium, 0.7%-2.0% by weight yttrium, and 10%-45% by weight tin; and the soldering flux includes: 25%-32% by weight rosin, 5%-7% by weight a mixture of pentane diacid and 2-Fluorobenzoic acid, as an organic acid activator; 0.2%-0.5% by weight alkylphenol polyoxyethylene, as a surface active agent; 0.7%-0.8% by weight 1-octyl alcohol, as a defoaming agent; 0.5%-0.7% by weight hydroquinone, as a stabilizer; and 20%-32% by weight a monoalkyl propylene glycol-based solvent.

The lead free solder composition of the invention has a solidus temperature no lower than 120° C., has good ductility and stability, and hence is suitable for soldering electrical connectors onto the metalized surface on the glass. Further, the soldering flux has strong wetting power for the lead-free solders; by using the soldering flux, the solders are uniformly spread, and residues generated after welding are soluble in water so that the printed board is high in insulating resistance after the soldering flux is cleaned with water.

### DETAILED DESCRIPTION OF THE PREFERRED EMBODIMENT

The present disclosure will be further illustrated in detail below in conjunction with some embodiments. It may be understood that specific embodiments described herein are merely for explaining the present disclosure rather than limiting the present disclosure.

The present disclosure provides a solder paste including a lead free solder composition and a soldering flux, which is suitable for soldering electrical elements on glass. Illustratively, such soldering is required for manufacturing a rear window of a car, which includes a window defroster consisting of electrically resistive defrosting lines embedded within or deposited on the inner surface of the rear window. The defrosting lines are electrically connected to a pair of electrical contact strips (i.e. electrical contact surfaces, also referred to as buss bars) located on the inner surface of the rear window. The electrical contact strips may consist of a conductive coating deposited on the inner surface of the rear window. Typically, the electrical contact strips are formed from silver-containing material.

To overcome the problem in the prior art, an embodiment of the invention provides a solder paste including a lead free solder composition and a soldering flux, and the lead free solder composition includes: 0.02%-6% by weight stibium, 0.03%-3% by weight copper, 0.03%-8% by weight bismuth, 42%-70% by weight indium, 0.3%-8% by weight silver, 5%-11% by weight magnesium, 0.8%-1.6% by weight scandium, 0.7%-2.0% by weight yttrium, and 10%-45% by weight tin. The soldering flux includes: 25%-32% by weight rosin, 5%-7% by weight a mixture of pentane diacid and 2-Fluorobenzoic acid, as an organic acid activator; 0.2%-0.5% by weight alkylphenol polyoxyethylene, as a surface active agent; 0.7%-0.8% by weight 1-octyl alcohol, as a defoaming agent; 0.5%-0.7% by weight hydroquinone, as a stabilizer; and 20%-32% by weight a monoalkyl propylene glycol-based solvent.

In the embodiment, the lead free solder composition includes scandium and yttrium, among which scandium has an effect of reducing a grain size and a feature of raising a recrystallization temperature and can enhance the ductility and stability of the solder, while yttrium is featured by high melting point, high strength and strong anti-corrosion, can enhance strength, high-temperature resistance and anti-corrosion of the solder, can avoid cracking of the solder joint, and increases the solidus temperature of the solder composition to be within a range from 120° C. to 135° C. and the liquidus temperature of the solder composition to be within a range from 130° C. to 145° C.

In some embodiments, the lead free solder composition may include 1.2%-1.4% by weight, more preferably 1.3% by weight, scandium.

In some embodiments, the lead free solder composition may include 1.4%-1.8% by weight, more preferably 1.6% by weight, yttrium.

In some embodiments, the lead free solder composition may include 3%-4% by weight stibium and 4%-5% by weight bismuth.

In some embodiments, the lead free solder composition may include 6%40% by weight, preferably 7%-9% by weight, more preferably 8% by weight, magnesium. In some other embodiments, the lead free solder composition may include 8%-9% by weight magnesium.

The monoalkyl propylene glycol-based solvent may be butyl propylene triglycol or butyl propylene diglycol, and can inhibit the reaction of the activator with metal contained in the solder alloy, thereby preventing formation of metal salt.

As mentioned above, the lead free solder composition in the solder paste of the invention has a solidus temperature within a range from 120° C. to 135° C. and a liquidus temperature within a range from 130° C. to 145° C. The solidus temperature is practically defined as the temperature at which an alloy begins to melt. Below the solidus temperature, the substance is completely solid, without molten phase. The liquidus temperature is the maximum temperature at which crystals (unmolten metal or alloy) can co-exist with the melt. Above the liquidus temperature, the material is homogeneous, consisting of melt only. The solder processing temperature is higher than the liquidus temperature, by a number of degrees that is determined by the soldering technique.

The solder composition of the invention is free of lead, and has a working temperature higher than that of other solder of the same type which is typically about 105° C. . Also, solder composition of the invention has much better ductility and stability, compared with the existing lead free solder composition in the prior art.

The combination of bismuth and copper with other elements improves the overall performance of the solder composition, including an expected increase of the working temperature of the solder and an enhancement of the mechanical performance of the solder under specific conditions.

In some embodiments, the lead free solder composition may have a solidus temperature in a range from 120° C. to 135° C.

Further in some embodiments, the solder composition may have a liquidus temperature in a range from 130° C. to 145° C.

In some embodiments, the lead free solder composition may include 3%-4% by weight stibium.

In some embodiments, the lead free solder composition may include 4%-5% by weight bismuth.

The lead free solder composition of the invention has a solidus temperature no lower than 120° C., has good ductility and stability, and hence is suitable for soldering electrical connectors onto the metalized surface on the glass.

Now the anti-cracking performance of the solder joint formed by the solder paste of the invention will be described below with comparison between the embodiments of the invention and some comparative examples, as shown in Table 1 below.

TABLE 1

| | | | | | | | Comp. | Comp. |
|---|---|---|---|---|---|---|---|---|
| | | Embodiment | Embodiment | Embodiment | Embodiment | Embodiment | Example | Example |
| | | 1 | 2 | 3 | 4 | 5 | 1 | 2 |
| Content | stibium | 1 | 2.3 | 4 | 4.3 | 5 | 4 | 5 |
| (% by | copper | 0.1 | 0.5 | 1 | 1.4 | 2 | 1 | 2 |
| weight) | bismuth | 0.5 | 1.5 | 3 | 5 | 7 | 3 | 5 |
| | indium | 42 | 50 | 55 | 60 | 70 | 45 | 60 |
| | silver | 0.5 | 1.5 | 2.5 | 4 | 6 | 2.5 | 4 |
| | magnesium | 5 | 7 | 8 | 9 | 10 | 8 | 9 |
| | scandium | 0.8 | 0.9 | 1.2 | 1.4 | 1.6 | 0.5 | 1.8 |
| | yttrium | 0.7 | 0.9 | 1.6 | 1.8 | 2.0 | 0.5 | 2.9 |
| | tin | 10 | 20 | 25 | 30 | 40 | 30 | 40 |

| | | | | | | | |
|---|---|---|---|---|---|---|---|
| Cracking | ✓ | ✓ | ✓ | ✓ | ✓ | x | x |
| Ductility | Good | Good | Good | Good | Good | Poor | Poor |

Note:
✓: cracking does NOT occur to adjacent solder joints during soldering
x: cracking occurs to adjacent solder joints during soldering

As can be seen from the above table, when scandium is contained at an amount in a range from 0.8%4.6% by weight in the solder composition, the cracking of the solder joint formed by the lead free solder composition of the invention can be avoided in the subsequent processes. However, when scandium is contained at an amount less than 0.8% by weight or larger than 1.6% by weight in the solder composition, the anti-cracking performance of the solder is degraded. Additionally, when yttrium is contained at an amount in a range from 0.7%-2.0% by weight in the solder composition, the solder joint formed by the lead free solder composition of the invention has good ductility. However, when yttrium is contained at an amount less than 0.7% by weight or larger than 2.0% by weight in the solder composition, the ductility performance of the solder is degraded.

High Temperature Storage Test

The ductility performance of the solder paste of the embodiments of the invention is tested by a high temperature storage test. In this test, the temperature of a climate controlled chamber was maintained at a constant 120° C., an electrical connector and a metalized surface on which the electrical connector was soldered by the solder of the invention were placed in the climate controlled chamber, and a weight of 6 Newtons was hung from the electrical connector for 24 hours. After the end of the 24 hours, the electrical connector was pulled (at ambient temperature) with a force of 50 N by a digital force gauge for 3 seconds, and no disconnection of cracking from the electrical connector occurred during this test.

It is noted that the preferable embodiments and the applied technology principles of the present disclosure are merely described as above. It should be understood for those skilled in the art that the present disclosure is not limited to particular embodiments described herein. Various apparent changes, readjustment and alternative can be made by those skilled in the art without departing the scope of protection of the present disclosure. Therefore, although the present disclosure is illustrated in detail through the above embodiments, the present disclosure is not merely limited to the above embodiments, and can further include more of other equivalent embodiments without departing the conception of the present disclosure. The scope of the present disclosure is subject to the appended claims.

1. A solder paste comprising a lead free solder composition and a soldering flux, the lead free solder composition, comprising:
0.02%-6% by weight stibium,
0.03%-3% by weight copper,
0.03%-8% by weight bismuth,
42%-70% by weight indium,
0.3%-8% by weight silver,
5%-11% by weight magnesium,
0.8%-1.6% by weight scandium,
0.7%-2.0% by weight yttrium, and
10%-45% by weight tin,
wherein the soldering flux comprises:
25%-32% by weight rosin,
5%-7% by weight a mixture of pentane diacid and 2-Fluorobenzoic acid, as an organic acid activator;
0.2%45% by weight alkylphenol polyoxyethylene, as a surface active agent;
0.7%-0.8% by weight 1-octyl alcohol, as a defoaming agent;
0.5%-0.7% by weight hydroquinone, as a stabilizer; and
20%-32% by weight a monoalkyl propylene glycol-based solvent.

2. The solder paste of claim 1, comprising 1.2%-1.4% by weight scandium.

3. The solder paste of claim 1, comprising 1.4%-1.8% by weight yttrium.

4. The solder paste of claim 1, wherein the lead free solder composition has a solidus temperature in a range from 120° C. to 135° C.

5. The solder paste of claim 1, wherein the monoalkyl propylene glycol-based solvent is butyl propylene triglycol or butyl propylene diglycol.
